(19) United States
(12) Patent Application Publication
(10) Pub. No.: US 2007/0220009 A1
(43) Pub. Date: Sep. 20, 2007

(54) Methods, systems, and computer program products for controlling access to application data

(76) Inventors: Robert Paul Morris, Raleigh, NC (US); Theodosios Thomas, Apex, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/376,386

(22) Filed: Mar. 15, 2006

(51) Int. Cl. G06F 17/30

(52) U.S. Cl. 707/10

(57) ABSTRACT

Methods, systems, and computer program products for controlling access to application data are disclosed. In one aspect, a trusted data store controls access to application data by a remotely hosted application. According to another aspect, an application executable instance is run in an application container on a trusted application server. According to yet another aspect, a client device controls processing of data in a remote application container.

### TECHNICAL FIELD

The subject matter described herein relates to controlling access to data by application servers. More particularly, the subject matter described herein relates to methods, systems, and computer program products for controlling access to application data associated with a client.

### BACKGROUND

In conventional networks, application data may be stored on an application server that uses the application data during an executable session. For example, when a consumer initiates a purchase transaction on an on-line retailer's web site, the client's credit card number, history of transactions, and other data may be provided to, generated at, and stored by the retailer's web server for at least the duration of the purchase transaction. This storage may be temporary, as when a client provides personal data during an executable session of an application, or may be persistent, as when a client agrees to store personal data on the server to facilitate future application processing. The application server is typically not owned or controlled by the client, and so the client cannot manage or guarantee how the data is used in the application server. Additionally, the client may be required to provide multiple instances of the data on a plurality of servers, where each server may be owned or managed by a different entity. For example, a client may conduct business with multiple on-line businesses such as a book seller, an airline company, or a furniture store, and provide a copy of personal identity and credit card information on a server associated with each business. Further each on-line business may track, generate, and store data associated with the client, and even receive and store data associated with the client from third-parties.

Server owners have conventionally addressed these difficulties using several technical and commercial solutions. Data transfers from a client to a server may be encrypted or encoded for transfer across a network to prevent an unauthorized network recipient from having the ability to recover and use the transferred data. Application server owners may provide written assurances that they will not misuse application data or propagate the application data to any third parties; however, the client has no means of verifying that the server owner is honoring that commitment.

Network data storage systems and services have also been introduced, where a client may store data and reference that data. These services, however, are designed to be accessed by the client and don't provide storage for application data for remotely hosted applications in a manner that is within the client's control.

Accordingly, in light of the above described difficulties associated with existing methods, there exists a need for improved methods, systems, and computer program products for controlling access to application data at a remotely hosted application.

### SUMMARY

The subject matter described herein includes methods, systems, and computer program products for controlling access to application data. In one aspect, access to application data at a remotely hosted application is controlled. A trusted data store may receive a request from a remote application for access to an application data element storage location associated with the application and a client of the application, and the request may include credentials for the client provided from a client device and for the remote application. The data store may authenticate the client credentials and the remote application credentials. Further, in response to authorization from the client, the data store may allow access to the storage location by the remote application based on access control information provided by the client of the client device, including allowing writing an application data element to the storage location.

In another aspect, data is processed in an application container. The application container may receive, from a remote client device, a request to provide credentials to the client device guaranteeing enforcement of a data usage policy defining allowable usage by the application of an application data element associated with a client of the client device. The application container may present the requested credentials to the client device for review without presenting the data usage policy. The application container may also provide an application to process the application data element while enforcing the data usage policy.

In yet another aspect, processing of data in a remote application container is controlled from a client device. A client device may request an executable session for communicating with a remote application container. The client device may provide authorization to a remote data store to permit the remote application container to access storage associated with an application data element associated with a client of the client device during the executable session. The client device may also provide authorization to the remote application container to allow a remote application to access the storage associated with the application data element during the executable session.

As used herein, the term “client” refers to a user of a network, a user of an application server, and/or a user of a trusted data store.

As used herein, the term “client device” refers to a physical or logical device that a client uses to access a network and control access to application data. For example, a client device may include an output display, an input device, such as a keyboard or mouse, a network interface, a browser or terminal subsystem, and/or an internal processing resource. The client device may also include a trusted data store manager. In an alternate implementation, a client device may include software that executes on a physical client device, such as a personal computer, mobile phone, or personal digital assistant, and that controls access to application data.

As used herein, the term “credential” refers to authentication information enabling the verification of the identity of the owner or provider of the credentials. For example, a credential can be a signature or certificate that may originate from a client device or application server and be validated by the receiving client device, application server, or a third-party trust authority. The certificate may be of any form suitable to the requesting client or server application. For example, an application server may provide a brand credential upon request and/or a client device may provide a credential for itself. A credential may be evaluated and verified at a remote data server, an application server, a trust authority server, or at a client device. Other examples of credentials include hash values, encrypted messages, or any information that allows verification of the identity of entity the credential represents.

As used herein, the term “application data element” refers to any data element associated with a client that is processed by the application, including a data element supplied by a client as input to an application executable directly or indirectly, a data element generated by the application, and a data element obtained from a party external to the application. Examples of application data elements include an account ID, a history of client activity, or a statistic generated by an application associated with a client or generated using data associated with a client.

In one exemplary implementation, an application data element may be stored at a trusted data store by a client device prior to initializing an application executable instance. For example, an application data element may be a set of preference settings, shipping address, or other data element for which a client may desire to control access.

As used herein, the term “application-generated data element” refers to any application data element created by an application executable instance which is associated with a client or created using an application data element associated with a client.

As used herein, the term “application container” refers to an operating environment container that may be established by a trusted application server for the duration of a session of an application executable instance requested by a client device. The application executable instance is monitored by and constrained by the application container based on a set of application data usage policies provided by or approved by a client. In one embodiment, a data usage policy may result in an application container ensuring that the application data is used only within the application instance for the duration of the session and that all copies of the application data used by the application instance on the server may be destroyed once the session is complete.

The subject matter described herein may be implemented using a computer program product comprising computer executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer-readable medium that implements the subject matter described herein may be distributed as represented by multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a block diagram of an exemplary system including a trusted data store, a trusted application server, a third-party trust authority, a client device, and a shared network according to an embodiment of the subject matter described herein;

FIG. 2 is a flow chart of an exemplary process for running an application executable session at a remote trusted application server using a client device and a trusted data store according to an embodiment of the subject matter described herein;

FIG. 3 is a block diagram showing additional details of an exemplary trusted data store including a trusted data store service manager, an application data element store, and a network interface according to an embodiment of the subject matter described herein;

FIG. 4 is a block diagram showing additional details of an exemplary client device including a network interface, a browser or terminal subsystem, an I/O subsystem, and further including a trust authority client and a trusted data store manager according to an embodiment of the subject matter described herein;

FIG. 5 is a block diagram showing additional details of an exemplary trusted application server including a network interface, a trusted application container, and an application session data element store according to an embodiment of the subject matter described herein;

FIG. 6 is a flow chart of an exemplary client device process for receiving and processing messages from a trusted application server and/or a trusted data store according to an embodiment of the subject matter described herein;

FIG. 7 is a flow chart of an exemplary trusted application server process for initiating, running, and terminating an application executable instance according to an embodiment of the subject matter described herein;

FIG. 8 is a flow chart of an exemplary trusted application container process for receiving, parsing, and further processing a received message according to an embodiment of the subject matter described herein;

FIG. 9 is a flow chart of an exemplary trusted application container process for transmitting a message according to an embodiment of the subject matter described herein;

FIG. 10 is a flow chart of an exemplary trusted application container process for receiving, parsing, and further processing a local I/O command according to an embodiment of the subject matter described herein;

FIG. 11 is a flow chart of an exemplary trusted data store process for receiving, parsing, and further processing a message received from a trusted application server according to an embodiment of the subject matter described herein;

FIG. 12 is a flow chart of an exemplary process for controlling access to application data by a remotely hosted application according to an embodiment of the subject matter described herein;

FIG. 13 is a flow chart of an exemplary process for securely processing application data in an application container according to an embodiment of the subject matter described herein; and

FIG. 14 is a flow chart of an exemplary process for controlling processing of data in a remote application container from a client device according to an embodiment of the subject matter described herein.

### DETAILED DESCRIPTION

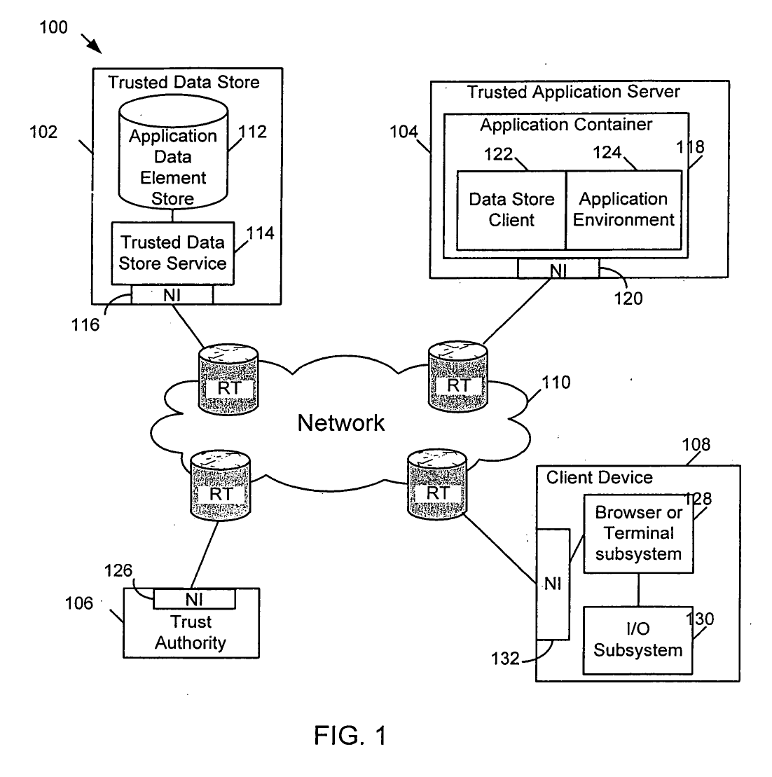

The subject matter described herein includes methods, systems, and computer program products for controlling access to application data by a remotely hosted application, processing application data in an application container, and controlling processing of data in a remote application container from a client device. FIG. 1 is a block diagram of an exemplary system 100 including a trusted data store 102, a trusted application server 104, a third-party trust authority server 106, a client device 108, and a shared network 110 according to an embodiment of the subject matter described herein. In FIG. 1, trusted data store 102 may include an application data element store 112 associated with a client of an application, a trusted data store service 114, and a network interface 116. The contents of application data element store 112 may include one or more application data elements and one or more data usage policies, as defined and instantiated by client device 108. For example, service 114 may receive a request from application server 104 for a copy of one or more application data elements. Application server 104 may be remote from trusted data store 102. Service 114 may request an authorization message from client device 108 before processing the request. If the request from application server 104 is validated, service 114 may extract the requested data element from application data element store 112 and forward the application data element to application server 104. Application server 104 may also request storage of an application data element on application data element store 112.

Application server 104 may include one or more application containers 118 and a network interface 120. Container 118 may also include a data store client 122 and an application environment 124. For example, data store client 122 may implement message and application data element transfers with trusted data store 102 as required by application environment 124. Application environment 124 may implement executable processing procedures defined by application server 104, as well as message and application data element transfer operations with client device 108.

Trust authority server 106 may include a network interface 126 and may provide procedures to periodically test trusted data store 102 and application server 104 on behalf of client device 108 to ensure that application data elements are used as specified by data usage policies. For example, trust authority 106 may poll trusted data store 102 to obtain a list of application servers requesting access to an application data element and the action trusted data store 102 took in response to each request. Likewise, trust authority 106 may poll application server 104 to verify that an application data element used in container 118 is not copied elsewhere in application server 104 in violation of a data usage policy. Trust authority 106 may also provide credentials trusted by a client or client device 108 to an application server 104 or application container 118 certifying that the server or container adheres to data usage policies defined by and/or approved by a client. The credentials may be sent to a client device 108 by a trusted application server 104 or container 118 to certify to the client or client device 108 that server 104 and/or container 118 is to be trusted to operate within the data usage policies. Alternately, client device 108 may forward credentials from an application server 104 or application container 118 to a trust authority 106 for certification of trust.

Client device 108 may include a browser or terminal subsystem 128, an I/O subsystem 130, and a network interface 132. Exemplary client devices include portable hand-held devices such as a cell phone, personal digital assistant (PDA), or the like. For example, browser or terminal subsystem 128 may include procedures to exchange messages across network 110 with trusted application server 104, trusted data store 102, and trust authority server 106. Browser or terminal subsystem 128 may also include resources to verify that application server 104 has established an application container 118 and has been enabled to access one or more application data elements in a trusted data store 102. Browser subsystem 128 may also include procedures to transfer messages between network interface 132 and I/O subsystem 130. I/O subsystem 130 may include processes and resources to operate a local display for a graphical user interface (GUI), a local keyboard, or a local mouse, or other local input devices.

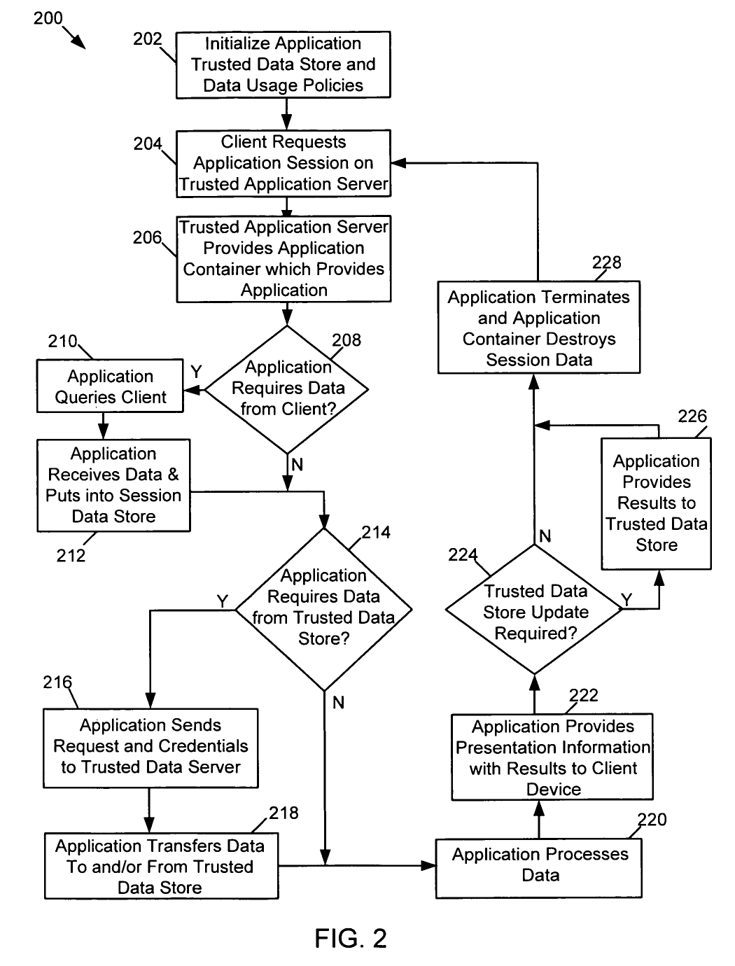

FIG. 2 illustrates an exemplary host process 200 for a system to run an application executable session in a container 118 at application server 104 using one or more application data elements according to an embodiment of the subject matter described herein. In FIG. 2, at block 202, client device 108 may initialize trusted data store 102 with one or more application data elements and/or data usage policies. Trusted data store 102 may be a network-based system operated by a third party under contract to a client, or may be an integrated component of client device 108. Client device 108 may also store one or more data usage policies. For example, client device 108 may provide a data usage policy for each application which has application data stored in a trusted data store 106 and/or may provide a policy for a specific application data element or set of elements. Some trusted data store 106 embodiments may maintain separate storage areas for each application with no overlap. Other embodiments may allow some storage locations to be shared across applications.

At block 204, client device 108 may request that application server 104 create a session with an instance of the application executable. The request message from client device 108 may include credentials which server 104 may validate before creating the application session. For example, the client may wish to shop on-line at a website owned by a clothing vendor. The client may use client device 108 to send a command to application server 104 to initialize an order-entry function using suitable webpage accesses and network messages.

At block 206, application server 104 may receive the client request message and provide an application container 118 for the session in response to the client request. Container 118 may include an instance of an application executable, plus a data store for one or more application data elements. For example, the clothing vendor website may provide a container 118 within the server 104 for the client session with an executable instance. The application may, for example, provide access to the vendor's product database and may include procedures to accept the client order and collect credit card data.

At decision point 208, the application executable may determine if any application data elements are required from client device 108. For example, the executable instance on the clothing vendor website may require the client to indicate the merchandise that the client is interested in purchasing or the preferred shipping arrangement. If application data elements from client device 108 are required, process 200 may proceed to block 210. Otherwise, process 200 may proceed to decision point 214.

At block 210, the application executable may cause application server 104 to send a request for application data elements to client device 108. For example, application server 104 may send an updated webpage to client device 108 with prompts for the required application data elements. This updated webpage may be shown on the display at client device 108.

At block 212, application server 104 may receive the requested application data elements from client device 108 and place them into an application session data element store in application container 118. Client device 108 may also provide one or more usage policies for the data elements. For example, the client may submit application data elements identifying a particular shirt of interest found on the clothing vendor's website. A usage policy may be provided with the data elements indicating that the data elements may not be placed in a separate shopper profile database.

At decision point 214, the application executable may determine if access to storage is required from trusted data store 102, as identified by client device 108. For example, the client may have selected a shirt to purchase from the clothing vendor website and has moved to the webpage where the clothing vendor requests shipping information. The application may save the selected shirt information in a storage location in the trusted data store 102 as part of the transaction processing and/or as part of a client activity log. If application data storage locations are to be accessed from trusted data store 102, process 200 may proceed to block 216. If no application data elements are required from trusted data store 102, process 200 may proceed to block 220.

At block 216, application server 104 may send a request for access to one or more application data storage locations to trusted data store 102 on behalf of the application executable. The request message sent to trusted data store 102 may include application server 104 credentials, which data store 102 may validate before permitting the requested access. Data store 102 may validate the server credentials, then authorize access either against a list of authorized servers or by sending an authorization request message to client device 104. For example, the clothing vendor's application executable may cause application server 104 to send a request for a shipping address to trusted data store 102 in order to complete the transaction.

At block 218, application server 104 may receive access to one or more requested application data storage locations and associated data usage policies from trusted data store 102. Server 104 may place received application data elements into container 118. For example, trusted data store 102 may allow read access to application data storage locations with the client's preferred shipping address as well as credit card information or a store credit account number, and calculate a discount based on transaction history data.

At block 220, application container 118 may allow the application executable to run using one or more received application data elements according to any data usage policies received with the application data elements. For example, the clothing vendor executable may be allowed to verify the payment information, update a billing record in an application storage location in the trusted data store 102, and cause an order for the requested shirt to be loaded into a production schedule in a remote trusted server.

At block 222, a presentation of the results is sent to the client device 108 in browser or terminal subsystem 128 for display on a local client GUI. For example, the clothing vendor executable may provide a transaction number for the client for subsequent use to check the status of the order using webpage update.

At decision point 224, the application executable may determine if one or more application data elements are to be written into trusted data store 102. For example, the clothing vendor's application executable may update the available value for a gift card account issued to the client and stored at trusted data store 102. The clothing vendor's application executable may also create a new application data element for the client indicating that the client is considered to be a preferred account. If updates to application data element in trusted data store 102 are required, process 200 may proceed to block 226. If no updates are required, process 200 may proceed to block 228.

At block 226, all application data elements identified at decision point 224 are forwarded to trusted data store 102 to be written into application data element store 112.

At block 228, an indication to terminate the session is received, typically from the client device 108, and the application is allowed to end the session including storing data and transferring data to locations allowed by the data usage policy. The container ensures that the application data session store is deleted and prevents the transfer or storage of application storage data elements to locations not allowed by the data usage policies, and deletes terminates the session.

The scenario provided above uses on-line shopping at a clothing vendor website to illustrate one implementation of the systems and methods described herein. In another example, application server 104 may be hosting a business application, such as a word processor, e-mail application, contacts application, spreadsheet application, and the like, that is remotely accessible to client device 108 via network 110 for processing application data, such as documents, emails, spreadsheets, contacts, and the like. It will be understood by one of ordinary skill in this art that the same procedures and configurations can be used as described or adapted for processing a business application, or any application.

### Exemplary Trusted Network Devices

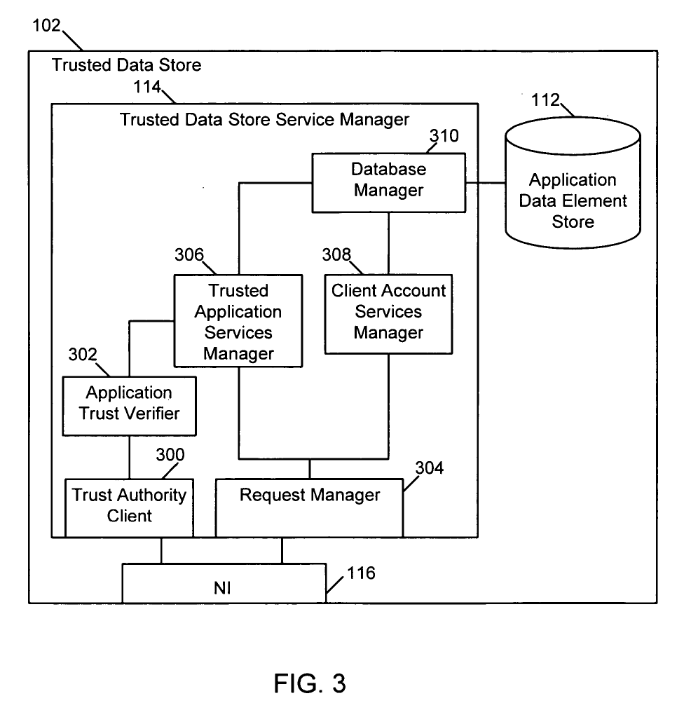

FIG. 3 is a block diagram showing additional details of trusted data store 102 shown in FIG. 1 according to an embodiment of the subject matter described herein. In FIG. 3, trusted data store service 114 may include a trust authority client 300, an application trust verifier 302, a request manager 304, a trusted application services manager 306, a client account services manager 308, and a database manager 310.

Trust authority client 300 may contain a message interface and procedures to exchange messages with third party trust authority server 106. For example, trust authority 106 may periodically request a log of recent transfers of all application data elements under the control of a client along with a list of application servers requesting each application data element, to verify that trusted data store 102 has not provided any application data elements to an unauthorized server.

Application trust verifier 302 may verify credentials received from applications making requests of the trusted data store 102. Verification may require communication with a trust authority server 106. Application trust verifier 302 may also review messages to be sent to remote applications, to verify that the identified destination server is authorized to receive the message.

Request manager 304 may provide processing for all data transfers between trusted data store 102 and either application server 104 or client device 108. Request manager 304 may implement procedures to validate the identity of the network device sending the request before transferring any application data elements using application trust verifier 302 and/or client account services manager 308. Any messages received from a non-registered or non-validated network device may be discarded by request manager 304. For example, request manager 304 may receive a plurality of application data element storage location access requests from either application server 104 or client device 108. Application server 104 may also request permission to write new values to application data element storage locations maintained at trusted data store 102 in application data element store 112. Similarly, request manager 304 may receive a request from client device 108 to add new application data elements to the collection of application data elements in storage in the application data element store 112 under the control of the client. Client device 108 may also send a request for access to one or more application data element storage locations controlled by the client to be retrieved from application data element store 112 and transferred to client device 108.

Trusted application services manager 306 may contain procedures to implement application data element transfer operations requested by application server 104 or trust authority 106. Application services manager 306 may also maintain a log of requested application data element storage transactions.

Client account services manager 308 may contain resources to implement data transfer operations requested by client device 108. For example, client account services manager 308 may include software for processing messages from client device 108 to control access to application data associated with applications used by the client.

Database manager 310 may implement all requested operations on one or more application data element storage locations defined by either trusted application services manager 306 or client account services manager 308. Database manager 310 may organize the contents of application data element store 112 using any suitable data storage arrangement. For application data element retrieval or storage requests, database manager 310 may extract a copy of, and/or store, one or more application data elements, as well as any data usage policies stored in application data element store 112 for the one or more application data element storage locations.

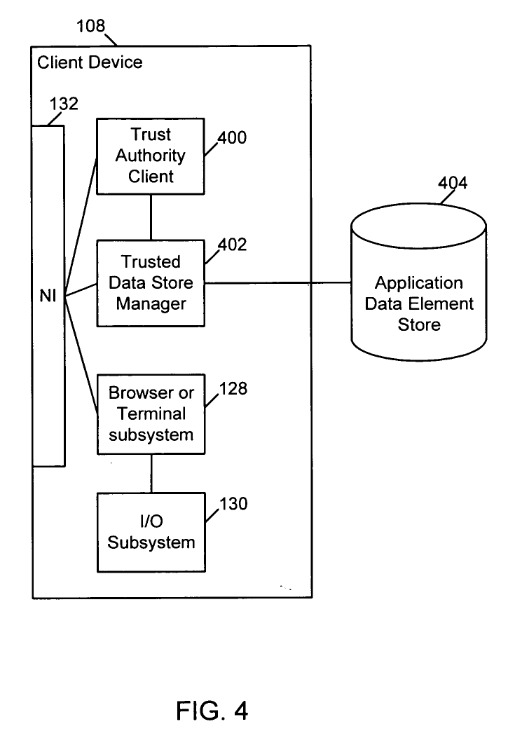

FIG. 4 is a block diagram providing additional details of client device 108 shown in FIG. 1 according to an embodiment of the subject matter described herein. In FIG. 4, client device 108 may include a browser or terminal subsystem 128, an I/O subsystem 130, a trust authority client 400, a trusted data store manager 402, an application data element store 404, and a network interface 132.

Trust authority client 400 may verify trust credentials received from application servers 104 and trusted data store 102 which may require communication with trust authority 106 via network interface 132.

Trusted data store manager 402 may provide access to application data elements stored in application data element store 404 by application server 104 after credentials have been validated by trust authority client 400 based on access control information provided by the client. For example, manager 402 may receive a plurality of messages from application server 104 to either extract a copy of one or more application data elements or to store a new application data element. Manager 402 may request validation of the application server request using trust authority client 400 and verify authorization before implementing the requested operation. For example, manager 402 may send an access authorization request to the client display through subsystem 128 and I/O system 130 and wait for a valid acknowledgement from an input device associated with client device 108 before implementing the requested access to application data element store 404. Manager 402 may also contain a database manager to control the contents of application data element store 404.

Application data store 404 may include one or more application data elements and any data usage policies for the application data element. The contents of application data store 404 may be organized according to any suitable data storage arrangement.

Network interface 132 may implement standard procedures to exchange messages on network 110 as well as procedures to transfer messages among trust authority client 400, trusted data store manager 402, and subsystem 128. For example, a client message transfer to application server 104 may originate at an input device controlled by I/O subsystem 130. This message may transit browser or terminal subsystem 128 and network interface 132 for transfer to application server 104. Similarly, a client request to access an application data element storage location in application data element store 404 may transit browser or terminal subsystem 128 and network interface 132 before entering trusted data store manager 402, which may perform the requested operation on the one or more application data element storage locations in application data store 404. This latter type of access requires the permission of the client.

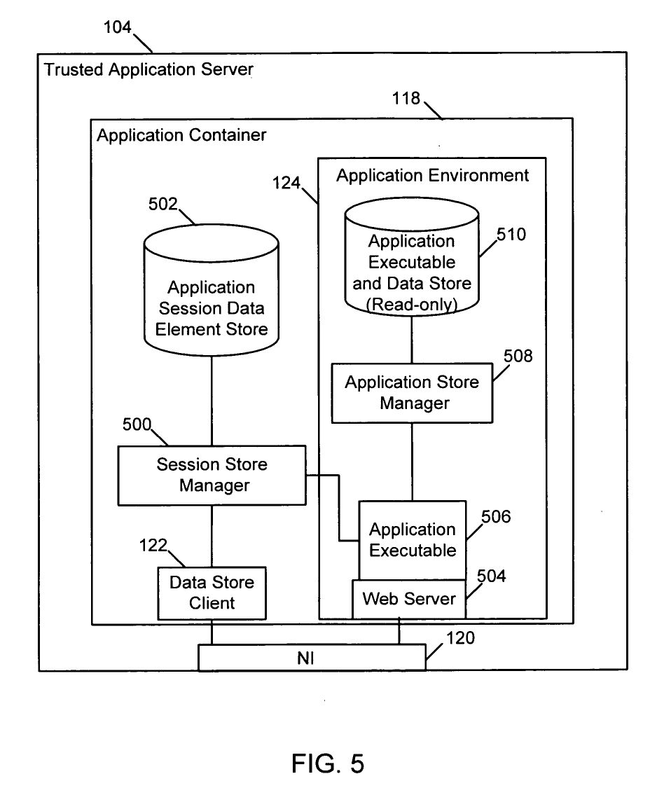

FIG. 5 is a block diagram providing additional details of trusted application server 104 shown in FIG. 1 according to an embodiment of the subject matter described herein. In FIG. 5, application server 104 may include network interface 120 and application container 118. Container 118 may further include data store client 122, application environment 124, a session store manager 500, and an application session data element store 502. Application environment 124 may further include a web server 504, an application executable instance 506, an application store manager 508, and an application executable and data store 510.

Network interface 120 may exchange messages with trusted data store 102, trust authority 106, and/or client device 108. Network interface 120 in conjunction with web server 504 may be capable of transmitting web page or similar application interface messages to client device 108 or receiving an application request from client device 108 and routing the received request to application executable 506. Network interface 120 in conjunction with data store client 122 may implement data transfer message exchanges with trusted data store 102.

Container 118 may manage application executable instance 506, plus one or more application data elements including one or more application-generated data elements. Procedures provided with container 118 may include monitoring the use by the application of each application data element and/or enforcing data usage policies associated with each application data element.

Session store manager 500 may provide an interface to application session data element store 502 for data store client 122 and for application executable 506. Data store client 122 may use session store manager 500 to transfer one or more application data elements between data store 502 and either client device 108 or trusted data store 102. Application executable instance 506 may use data store manager 500 to access application data elements in application session data element store 502. Session store manager 500 may also include a data store manager controlling the organization of the contents of application session data element store 502.

Application session data element store 502 may store application data elements associated with application executable 506 on behalf of a remote client while the remote client is using the application. These application data elements may comprise application data elements received from client device 108 or application data elements received from a trusted data store 102. Application executable 506 may also store interim values for application-generated data elements created during the application session. The contents of application session data element store 502 may be organized according to any suitable data storage arrangement.

Web server 504 may host webpage scripts used by trusted application server 104 and trusted application container 118 to display information on a GUI at client device 108. Web server 504 may also include procedures to accept input from client device 108.

Application executable instance 506 may be provided by trusted application service provider 104 following receipt of a request for an executable instance from client device 108. Executable instance 506 may be restricted to using application data elements and data store resources contained within container 118. Executable instance 506 and any associated data values may be read by application executable and data store 510 via application store manager 508. Application executable and data store 510 may provide storage for unloaded executable code and application data needed for operation but not associated with a client such as application initialization and configuration, inventory data, application credentials, etc. Data store 510 may be a read-only storage resource to the application executable 506.

### Exemplary Message Processing in a Client Device

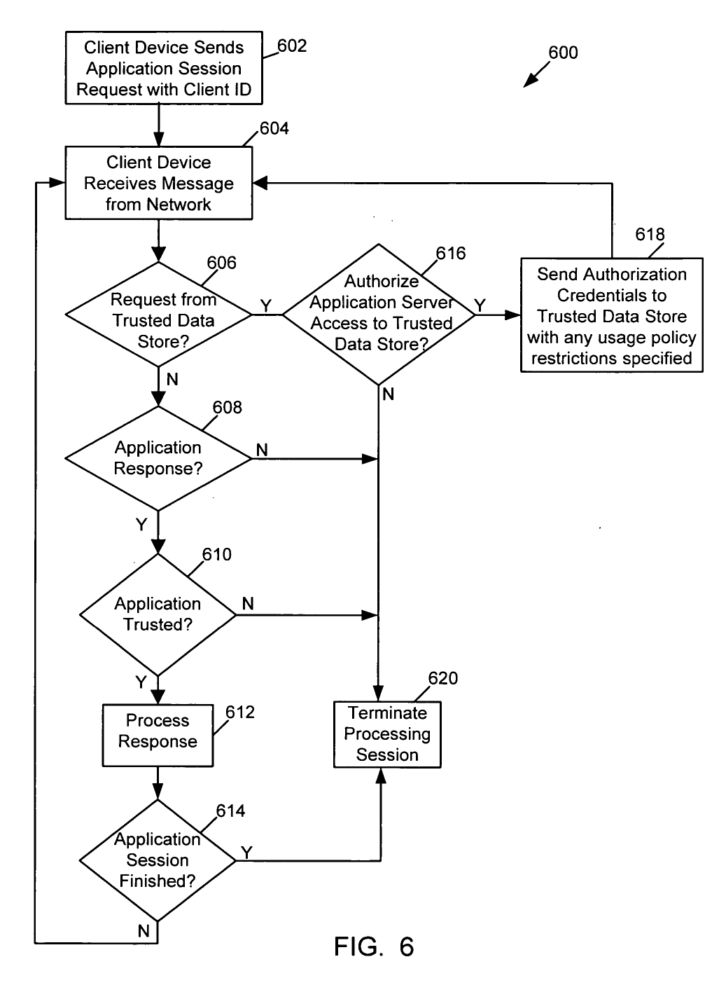

FIG. 6 is a flow chart illustrating an exemplary process 600 at client device 108 which may process one or more messages received from either trusted data store 102 or application server 104 shown in FIG. 1 according to an embodiment of the subject matter described herein. These messages may contain requests directed to client device 108 to either receive or transmit one or more application data elements associated with application executable 506 initiated in container 118. In FIG. 6, at block 602, client device 108 may send a message to application server 104 to initiate an executable instance 506, providing appropriate client credentials in the request message.

At block 604, client device 108 may wait to receive a message from application server 104 or trusted data store 102. Client device 108 may also implement a procedure to test the received message for errors, including verifying the source of the received message.

Decision points 606, 608, and 610 may jointly implement a message parsing procedure to define the task required at client device 108 based on the source of the received message.

At decision point 606, the received message may be tested to determine if it originated at trusted data store 102. If so, process 600 may proceed to decision point 616. If not, process 600 may proceed to decision point 608.

At decision point 608, the received message may be tested to determine if it originated at trusted application server 104. If so, process 600 may proceed to decision point 610. If not, the message may be presumed to have originated at an unrecognized server, and process 600 may proceed to block 620.

At decision point 610, client device 108 may verify that application server 104 sending the message is trusted by client device 108. If application server 104 is trusted, process 600 may proceed to block 612. Otherwise, process 600 may proceed to block 620.

At block 612, client device 108 may process the received message. For example, if client device 108 has sent a request to initiate executable instance 506 at application server 104, the received message from application server 104 may acknowledge the request and contain a request for one or more application data elements to be provided by client device 108. The message may also contain presentation information which is displayed to the client via browser of terminal subsystem 128. The process response procedures at block 612 may include transmission of additional messages or application data elements to either application server 104 or trusted data store 102.

At decision point 614, client device 108 may determine if additional interactions with application server 104 are required. If so, process 600 may proceed to block 604 to wait for another received message. If not, process 600 may proceed to block 620.

At decision point 616, client device 108 may decide to permit application server 104 to access application data element storage locations in trusted data store 102. If this authorization is granted, process 600 may proceed to block 618. If this authorization is not granted, process 600 may proceed to block 620.

At block 618, client device 108 may send a message to trusted data store 102 authorizing access to the requested application data element storage locations to application server 104. Once the procedure at block 618 completes, process 600 may proceed to block 604 to wait for a received message from the network.

At block 620, client device 108 may terminate all processing associated with the request message that was originally generated in block 602. This procedure may be started once all application executable processing is complete or upon detection of a messaging error in any of the message parsing procedures invoked in process 600.

In addition to processing messages received from trusted data store 102 and trusted application server 104, client device 108 may receive messages from trust authority 106 or from other network entities. Messages from these other sources may be processed using procedures independent of process 600.

### Exemplary Message Processing in a Trusted Application Server

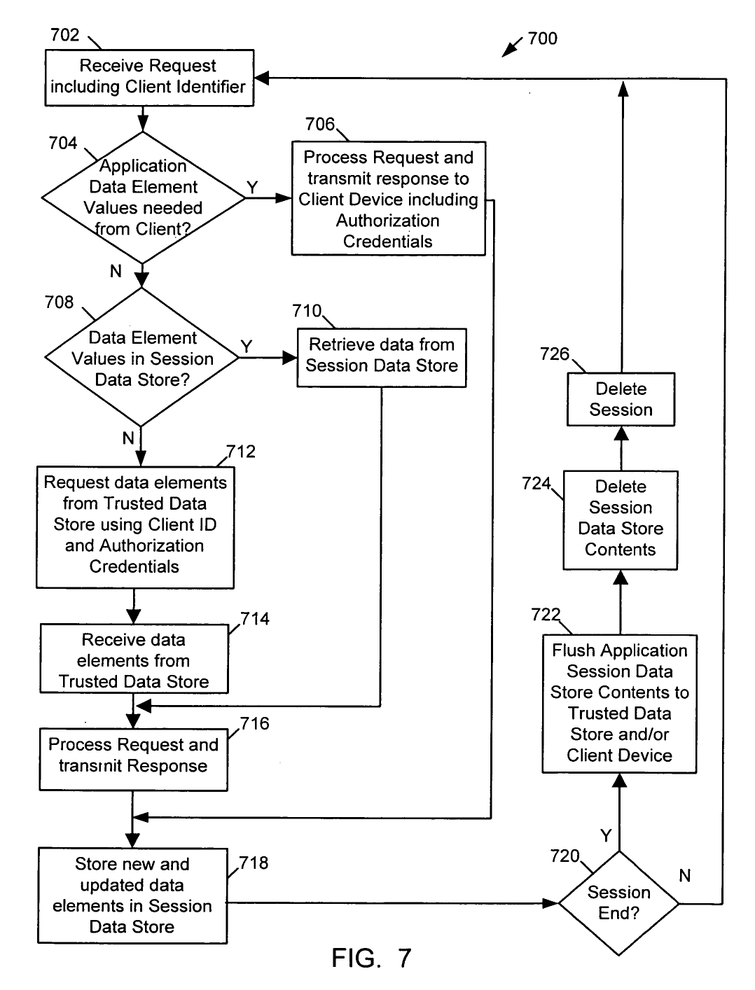

FIG. 7 is a flow chart illustrating an exemplary process 700 at trusted application server 104 to initiate, run, and terminate a session of application executable instance 506 according to an embodiment of the subject matter described herein. In FIG. 7, at block 702 application server 104 may receive a request for a session with an application executable instance from client device 108. This request may include a client identifier and may also include an identifier for a trusted data store 102 to be accessed for one or more application data elements. In an alternate embodiment of the subject matter described herein, the trusted data store may be allowed to store the trusted data stored identifier locally associated with the client identifier so it does not have to be sent each time from the client device 108. For example, client device 108 accessing a clothing vendor website may request a session to process an order by clicking on a link in a webpage.

Decision points 704 and 708 may jointly implement a message parsing procedure to permit application server 104 to determine the source of the application data elements.

At decision point 704, application server 104 may determine if one or more application data elements are required from client device 108. If so, process 700 may proceed to block 706. If not, process 700 may proceed to decision point 708.

At block 706, application server 104 may process the request from client device 108. In response, application server 104 may send a response message containing an acknowledgement of the request received from client device 108, plus application server trust credentials and a request for one or more application data elements. For example, the executable instance 506 may request a product code or a quantity from client device 108. Once the procedures associated with block 706 are complete, process 700 may proceed to block 718.

At decision point 708, application server 104 may determine if one or more application data elements are available at application session data element store 502. If so, process 700 may proceed to block 710 to retrieve the application data elements from session data store 502. If application server 104 determines that none of the required application data elements are present in session data store 502, process 700 may proceed to block 712.

At block 710, application server 104 may copy the required application data elements located in session data store 502 for use with executable instance 506. For example, the client's shipping address and customer profile information may already be captured in session data store 502 for an earlier transaction that client device 108 completed through the same session on the clothing vendor's website. Once the procedures associated with block 710 have completed, process 700 may proceed to block 716.

At block 712, application server 104 may transmit a message to trusted data store 102 requesting access to one or more application data element storage locations specified by executable instance 506 or by client device 108. For example, application server 104 may request a transaction history or customer type or store voucher account number from trusted data store 102 in processing the order. Application server 104 may include the client identifier and a trust authorization credential.

At block 714, application server 104 may wait to receive a response message from trusted data store 102 with the one or more application data elements requested at block 712. Trusted data store 102 may autonomously send a request to client device 108 to authorize the request message before responding to the message sent by application server 104 at block 712. Trusted data store 102 may also send any data usage policies associated with the one or more requested application data elements from the accessed storage locations.

At block 716, application server 104 may verify that it has obtained all required application data elements from either session data store 502 or from trusted data store 102. Once this verification is complete, application server 104 may perform additional processing and send a confirmation message to client device 108 which may be enabled to be presented on the display of the client device 108.

At block 718, some or all application data elements collected by application server 104 using procedures at blocks 706, 710, 712, 714, and 716 may be placed in application session data element store 502 and/or may be written to trusted data store 102.

At decision point 720, application server 104 may check the operating status of the session to determine if its operation is to continue. If the session is to be ended, process 700 may proceed to block 722. If the session is to continue, process 700 may return to block 702 to wait for the next request.

At block 722, application server 104 may transfer one or more application data elements including application-generated data elements to trusted data store 102 storage locations. For example, application executable instance 506 may generate an updated account balance for a store credit voucher account at the completion of the requested transaction, which may need to be written back to trusted data store 102 for a future operation. Application server 104 may also transfer one or more application data elements including application-generated data elements to client device 108. For example, application executable 506 may generate an order verification number to be shown on client device 108 display for future use.

At block 724, application server 104 may delete all application data elements associated with session in the client application session data element store 502.

At block 726, application server 104 may delete the session from the application executable instance 506 and associated storage area in the session data store 502. Process 700 may proceed to block 702 to wait for the next message requesting a session with an application executable instance 500 from client device 108.

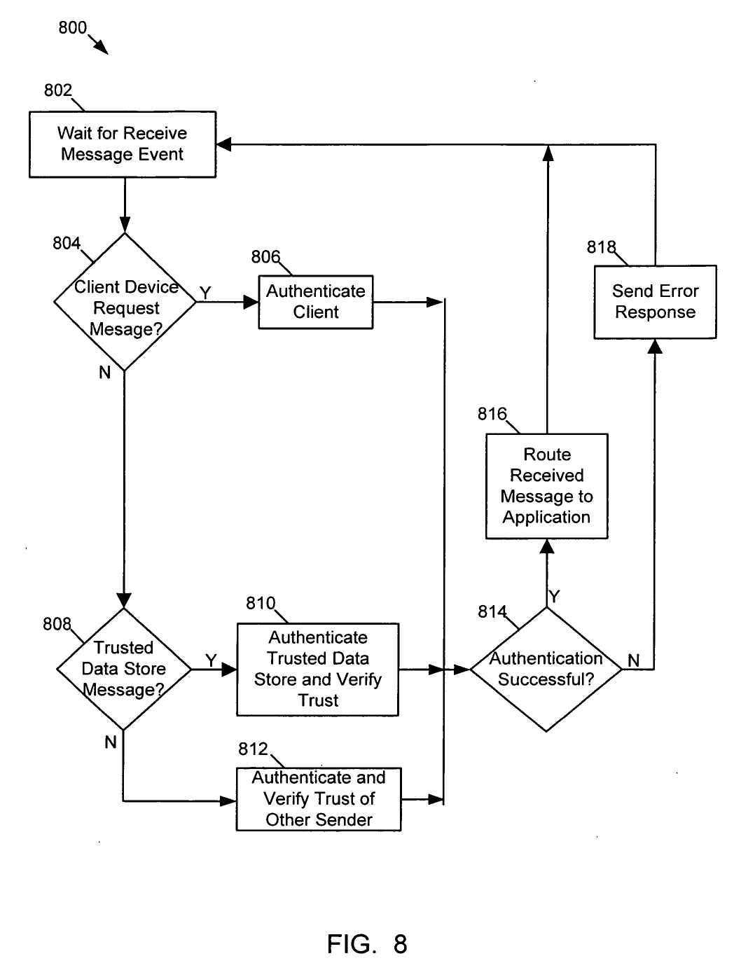

FIG. 8 is a flow chart illustrating an exemplary process 800 run in application container 118 to receive, parse, and further process a received message according to an embodiment of the subject matter described herein. In FIG. 8, at block 802 container 118 may wait to receive the message from client device 108, trusted data store 102, trust authority server 106, or another source.

Decision points 804 and 808 may jointly provide a procedure to parse the received message to permit container 118 to determine authentication requirements before providing the received message to an application executable instance 506 for processing.

At decision point 804, container 118 may check message information associated with the received message to determine if the message originated at client device 108. If so, process 800 may proceed to block 806 in order to authenticate the client device 108. If not, process 800 may proceed to decision point 808.

At decision point 808, container 118 may check message information associated with the received message to determine if it originated at trusted data store 102. If so, process 800 may proceed to block 810 in order to authenticate the message and validate the trust assigned to trusted data store 102. If not, process 800 may proceed to block 812 in order to authenticate the message and validate the trust assigned to trust authority 106 or other sender.

Once the appropriate authentication procedures associated with blocks 806, 810, or 812 have completed, process 800 may proceed to decision point 814 to determine if the authentication procedure is successful. If authentication succeeds, process 800 may proceed to block 816; otherwise, process 800 may proceed to block 818.

At block 816, the received message may be provided to application executable instance 506 for further processing if allowed by the data usage policy. Upon completion of this procedure, process 800 may proceed to block 802 to wait for another received message.

At block 818, container 118 may send an error message to the sending network device. The original message received at block 802 may be discarded, and process 800 may proceed to block 802 to wait for another received message.

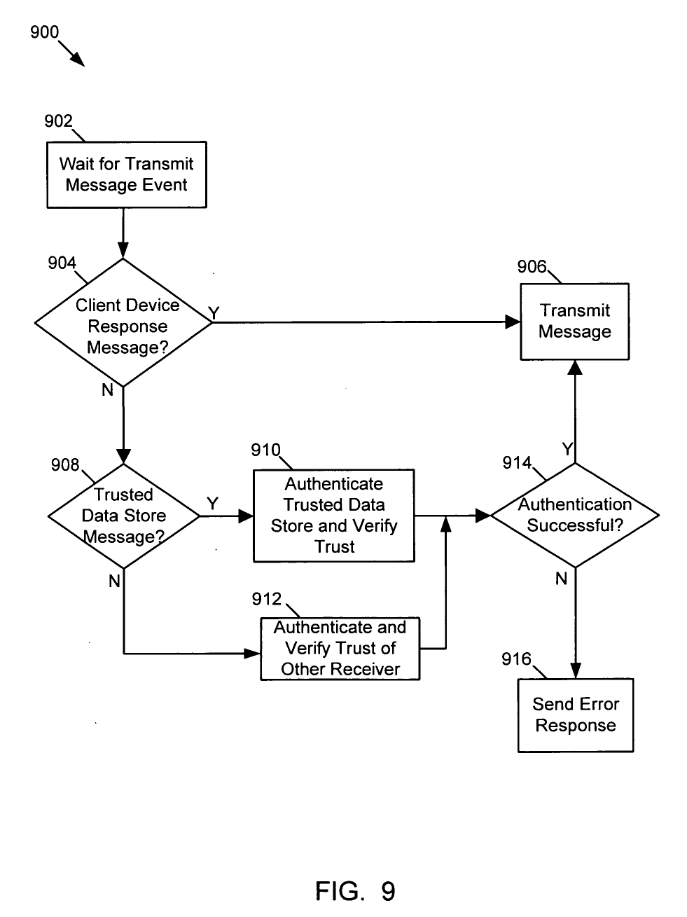

FIG. 9 is a flow chart illustrating an exemplary process 900 to transmit a message from application container 118 originating from application executable instance 506 according to an embodiment of the subject matter described herein. In FIG. 9, at block 902 container 118 may wait to transmit a message to client device 108, trusted data store 102, or trust authority server 106 as requested by the application executable instance 506.

Decision points 904 and 908 may jointly provide a procedure to determine the destination of the message for final processing before transmitting the message.

At decision point 904, container 118 may determine if the message is destined for client device 108. If so, process 900 may proceed to block 906. If not, process 900 may proceed to decision point 908.

At block 906, container 118 may transmit the message according to any usage policy restrictions for the client data elements, as some data usage policies may restrict the data that can be sent to the client. For example, client device 108 may have already been authenticated by another process or procedure executed in container 118 and may have already provided one or more usage policies to container 118. Following completion of the procedure associated with block 906, container 118 may terminate process 900, invoke process 800 and proceed to block 802 to wait for a received message event.

At decision point 908, container 118 may determine if the message is destined for trusted data store 102. If the message is to be transferred to trusted data store 102, process 900 may proceed to block 910. If it is to be transferred to trust authority 106 or to another receiver, process 900 may proceed to block 912.

At block 910, container 118 may implement a procedure to authenticate and verify the trust level assigned to trusted data server 102. Process 900 may proceed to decision point 914.

At block 912, container 118 may implement a procedure to authenticate and verify the trust level assigned to trust authority 106 or another receiver.

At decision point 914, container 118 may determine if the authentication test conducted in either block 910 or 912 is successful. If so, process 900 may proceed to block 906 to transmit the message in compliance with data usage policies in effect. Otherwise, process 900 may proceed to block 916.

At block 916, container 118 may return an error message to executable instance 506 and may discard the message provided at block 902. Following completion of the procedure associated with block 916, container 118 may terminate process 900, invoke process 800 and proceed to block 802 to wait for a received message event.

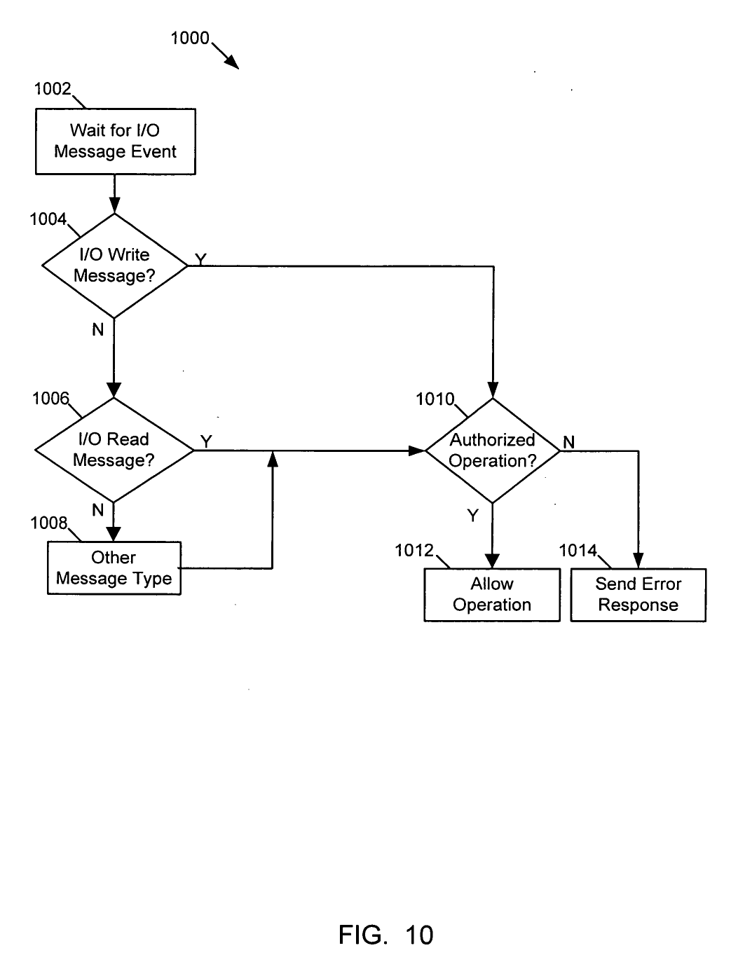

FIG. 10 is a flow chart illustrating an exemplary process 1000 to receive, parse, and further process a local I/O command in application container 118 according to an embodiment of the subject matter described herein. In FIG. 10, at block 1002, container 118 may wait to receive a message from within application server 104 to implement an I/O read or write function on the application data elements of a session of the application executable instance 506.

Decision points 1004 and 1006 may jointly implement a procedure to parse a message received at block 1002 to determine the type of I/O operation to be performed by container 118.

At decision point 1004, the received message may be tested to determine if it contains an I/O write command and associated data to a destination outside the application container 118. If so, process 1000 may proceed to block 1010. If not, process 1000 may proceed to decision point 1006.

At block 1006, the received message may be tested to determine if it contains an I/O read command and associated data from a location outside the application container 118. If so, process 1000 may proceed to decision point 1010. If not, process 1000 may proceed to block 1008.

At decision point 1008, the received message is determined to be some other I/O operation, so process 1000 may proceed to decision point 1010 passing information associated with the operation requested.

At decision point 1010, the I/O command identified may be checked to determine if it is authorized based on the data usage policies in effect for the session. If so, process 1000 may proceed to block 1012 to allow the operation requested. If the command is not authorized, process 1000 may proceed to block 1014, and container 118 may send an error response message to the source of the I/O message and discard the message received at block 1002. Following completion of procedures associated with either block 1012 or 1014, container 118 may terminate process 1000, invoke process 800, and proceed to block 802 to wait for a received message event.

### Exemplary Message Processing in a Trusted Data Store

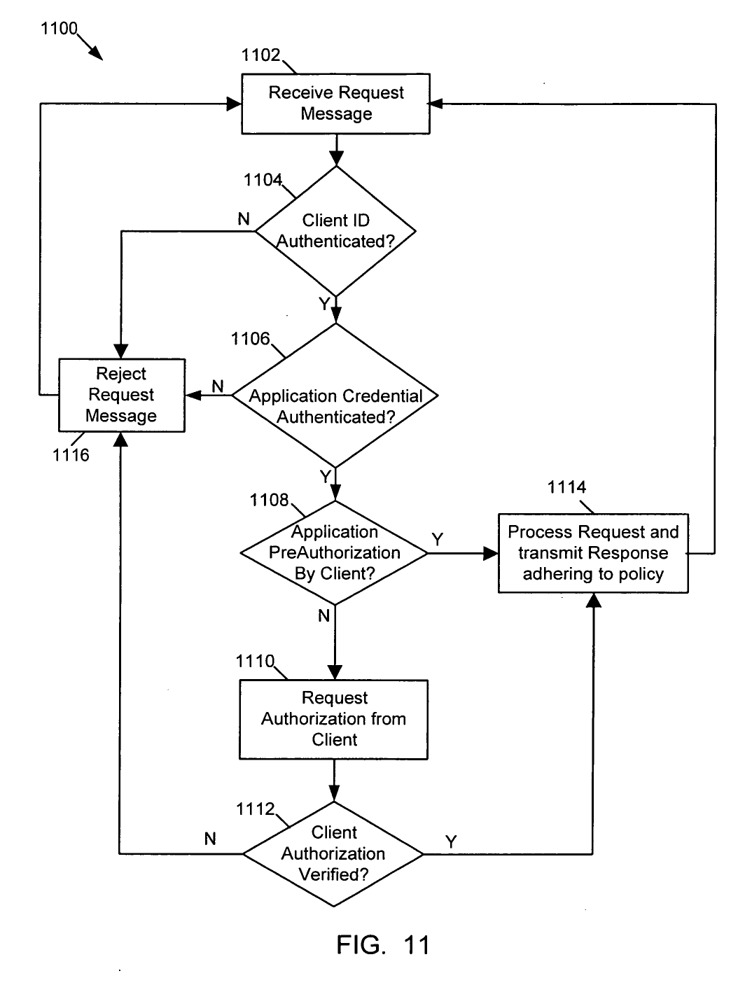

FIG. 11 is a flow chart illustrating an exemplary process 1100 to receive, parse, and further process a message received at trusted data store 102 from trusted application server 104 according to an embodiment of the subject matter described herein. In FIG. 11, at block 1102 trusted data store 102 may receive an access request message from trusted application server 104.

Decision points 1104, 1106, and 1108 may jointly implement a message parsing procedure to determine the origin of the received message, authenticate the message, and determine the level of authorization assigned to the originator within trusted data store 102.

At decision point 1104, trusted data store 102 may verify that client device 108 identified in the received message is registered and has an appropriate authentication. If so, process 1100 may proceed to decision point 1106. Otherwise, process 1100 may proceed to block 1116.

At decision point 1106, trusted data store 102 may verify that application server 104 identified in the received message has previously been authenticated by trusted data store 102. If so, process 1100 may proceed to decision point 1108. Otherwise, process 1100 may proceed to block 1116.

At decision point 1108, trusted data store 102 may determine if an authorization for commands from application server 104 has already been registered by client device 108. If not, process 1100 may proceed to block 1110. Otherwise, process 1100 may proceed to block 1114.

At block 1110, trusted data store 102 may transmit a message to client device 108 requesting client authorization for the operation requested by trusted application server 104. Process 1100 may wait at block 1110 until an authorization response is received from client device 108 before proceeding to decision point 1112.

At decision point 1112, the message received from client device 108 may be inspected for authorization verification. If client device 108 has transmitted a valid authorization verification, process 1100 may proceed to block 1114. Otherwise, process 1100 may proceed to block 1116.

At block 1114, trusted data store 102 may process the contents of the message received at block 1102 and transmit an appropriate response to application server 104. Upon completion of the procedure associated with block 1114, process 1100 may proceed to block 1102 to wait for the next received message.

At block 1116, trusted data store 102 may reject the receive message as being flawed and destroy it. Trusted data store 102 may send an error response message to application server 104. Upon completion of the procedure associated with block 1116, process 1100 may proceed to block 1102 to wait for the next received message.

### Exemplary Methods for Remotely Processing Application Data

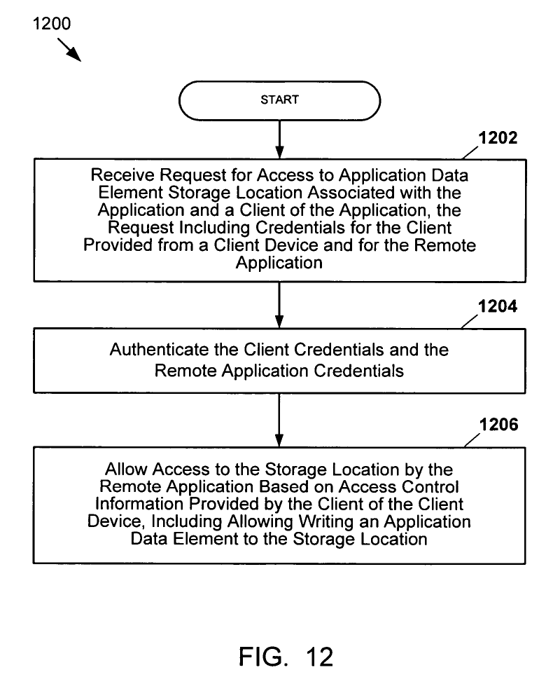

FIG. 12 is a flow chart illustrating an exemplary process 1200 for controlling access to application data by a remotely hosted application. In block 1202, a request is received by the trusted data store 102 from a remote application for access to an application data element storage location associated with the application and a client of the application. The request includes credentials for the client provided from a client device and for the remote application. For example, a client device 108 may instantiate an application executable session 506 in an application container 118 on a trusted application server 104. Server 104 may host a website, and client device 108 may be required to supply a plurality of input data elements in order to allow the application session to complete. Trusted data store 102 may receive a request from application session 506 for permission to access certain data elements locations controlled by the client that are stored at remote trusted data store 102. The request message received from server 104 may include server credentials and/or credentials for the client device that originally requested the application session to be instantiated.

In block 1204, the client credentials and the remote application credentials are authenticated. For example, trusted data store 102 may test received client device credentials to determine if they are valid. In one implementation, if the client device credentials are valid, data server 102 may have the ability to further interrogate client device 108 to validate the request for accessing data elements owned by client device 108. If the client credentials are not valid, or the client device is not authorized to own any data elements on the trusted data server, the trusted data server may stop the process and return an error message to application server 104. Trusted data store 102 may also inspect the received message to determine if it includes any application server credentials, and to determine if the received credentials are valid. The test for validity may include sending a message to client device 108 requesting authorization of the request from application server 104.

In block 1206, access to the storage location by the remote application is allowed based on access control information provided by the client of the client device, where allowing access by the remote application includes allowing writing an application data element to the storage location. For example, trusted data store 102 may complete the data element accesses requested in the original message from application session 506. Trusted data store 102 may implement write operations to create new data element locations and/or store new instance values for data elements owned by client device 108. Trusted data store 102 may also read specified data element locations and extract instance values. The trusted data store 102 may send a confirmation message to application server 104 indicating that the requested data operations have been completed. The message may also include instance values for any data element locations that were requested to have been read.

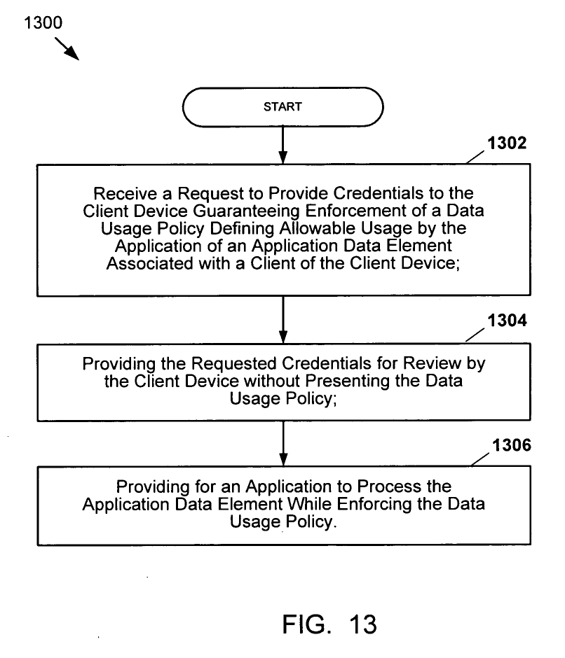

FIG. 13 is a flow chart illustrating an exemplary process 1300 in an application container 118 for processing application data in an application container. In block 1302, a request is received from a remote client device to provide credentials to the client device guaranteeing enforcement of a data usage policy defining allowable usage by the application of an application data element associated with a client of the client device.

For example, a remote client 108 may request instantiation of an application executable session to process data element values supplied by the client and to return application data element values possibly generated by the application executable session to the client at completion of or during the application executable session. The application container 118 may receive a message from client device 108 requesting credentials from the server in order to initiate an application executable session. The message received may include one or more credentials identifying the client device. Application container 118 may validate client device 108.

In block 1304, the requested credentials are provided for review by the client device without presenting the data usage policy. For example, application container 118 may submit one or more server credentials to client device 108. These credentials may include a commitment to process one or more client data elements in a closed container according to a data usage policy associated with the credentials. Note that providing the credential obviates the need to provide a user readable data usage policy, such as a privacy policy.

In block 1306, the application container 118 provides for an application to process the application data element while enforcing the data usage policy. For example, application container 118 may instantiate a session of application executable 506 and reserve storage locations in session data store 502 for data elements associated with application session 506.

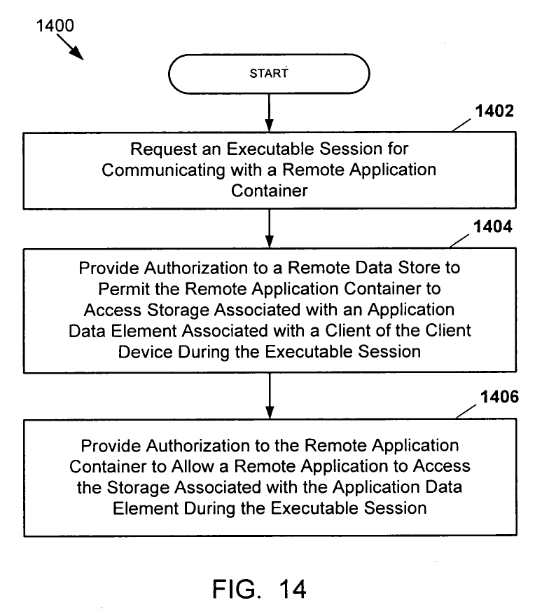

FIG. 14 is a flow chart illustrating a method 1400 for controlling processing of data in a remote application container from a client device at a client device. For example, client device 108 may instantiate an executable session 506 of an application at a remote server 104, and may supply instance values for client data elements either directly from client device 108 or through reference to data elements stored in a trusted data store 102. Application-generated results from application executable session 506 may be presented to client device 108 and/or stored in trusted data store 102.

In block 1402 client device 108 requests an executable session for communicating with a remote application container 118. For example, client device may receive a request for an application executable session from an input device through I/O subsystem 130 and may send a request message to application server 104 to instantiate an application executable session 506 in an application container 118. Client device 108 may also send a message including one or more credentials for self-authentication and authorization purposes to application server 104. Client device 108 may determine if application session 506 requires any data element instance values directly from the client. If so, client device 108 may implement interactive procedures to display the one or more data elements requiring instance values and to collect the one or more instance values through a local input device controlled by I/O subsystem 130.

In block 1404, authorization is provided to trusted data store 102 to permit remote application container 118 to access storage associated with an application data element associated with a client of the client device 108 during the executable session. For example, client device 108 may submit one or more access authentication and authorization credentials to trusted data store 102, identifying application server 104 and target application session 506. Client device 108 may either send the one or more credentials autonomously or upon request of trusted data store 102. Trusted data store 102 may validate the one or more authorization credentials from client device 108 with credentials supplied by application server 104.

In block 1406, authorization is provided to remote application container 118 to allow a remote application to access the storage associated with the application data element during the executable session. For example, client device 108 may provide one or more access authorization credentials to the application executable session in order to permit application container 118 to access one or more data elements.

A system for controlling access to application data by a remotely hosted application may include means for receiving, from a remote application, a request for access to an application data element storage location associated with the application and a client of the application, the request including credentials for the client provided from a client device and for the remote application. For example, request manager 304 and/or trusted application services manager 306 in trusted data store 102 may receive and validate one or more request messages from application executable instance 506 in application container 118. Trusted application services manager 306 may utilize application trust verifier 302 to perform the message parsing procedures in decision points 1104, 1106 and 1108 to validate the request message from application server 104.

A system for controlling access to application data by a remotely hosted application may also include means for authenticating the client credentials and the remote application. For example, application trust verifier 302 in trusted data store 102 may use procedures associated with process 1100 block 1110 and decision point 1112 to implement this verification procedure. Client device 108 may utilize procedures associated with decision points 606 and 616, as well as block 618 to provide the requested verification.

A system for controlling access to application data by a remotely hosted application may also include means for allowing access to the storage location by the remote application based on access control information provided by the client of the client device, wherein allowing access by the remote application includes allowing writing an application data element to the storage location. For example, application executable instance 506 may have application-generated data element values to be written to data element storage locations in trusted data store 102. Application container 118 may send those values to trusted data store 102 using methods associated with process 200 decision point 224 and block 226. Database manager 310 may utilize procedures associated with process 1100 to implement the requested write operation once trusted application services manager 306 utilizing application trust verifier 302 completes the authentication process.

A system for processing data in an application container may include means for receiving, from a remote client device, a request to provide credentials to the client device guaranteeing enforcement of a data usage policy defining allowable usage by the application of an application data element associated with a client of the client device. For example, client device 108 may send a request message to trusted application server 104 to initiate a session with an application executable instance, using procedures associated with block 602. Application server 104 may receive the message, initiate process 200, and utilize procedures associated with block 206 to instantiate a session within application container 118. Container 118 may initialize application environment 124 along with session store manager 500 and application session data element store 502. Application environment 124 may include web server 504, plus application executable instance 506 with application store manager 508 and application executable and data store 510. Application server 104 may send an acknowledgement response to client device 108 as part of the procedures associated with process 700.

A system for processing data in an application container may also include means for providing the requested credentials for review by the client device without presenting the data usage policy. For example, application executable instance 506 and/or container 118 may transmit the appropriate credentials to client device 108 using procedures associated with blocks 206 and process 800.

A system for processing data in an application container may also include means for providing an application to process the application data element while enforcing the data usage policy. For example, container 118 may collect all required application data elements and data usage policies and load them into application session data element store 502 using procedures associated with process 700 blocks 706, 710, 712, 714, 716, and 718. Once the application data elements are stored in data store 502, container 118 may launch a session of application executable 506 according to procedures associated with block 220. Application executable 506 may place all or a portion of results of its operation using application data elements into application session data element store 502 through session manager 500.

A system for controlling processing of data in a remote application container from a client device may include means for requesting an executable session for communicating with a remote application container. For example, browser 128 in client device 108 may send a message to trusted application server 104 requesting a session with application executable instance 506 in container 118 following procedures associated with process 200 block 204 and/or process 600 block 602. Trusted application 104 may utilize procedures associated with process 700 to instantiate the required resources and send an acknowledgement to client device 108.

A system for controlling processing of data in a remote application container from a client device may also include means for providing authorization to a remote data store to permit the remote application container to access storage associated with an application data element associated with a client of the client device during the executable session. For example, container 118 may request application data elements from trusted data store 102 using procedures associated with process 700 block 712.

A system for controlling processing of data in a remote application container from a client device may also include means for providing authorization to the remote application container to allow a remote application to access the storage associated with the application data element during the executable session. For example, session store manager 500 may send a request to browser subsystem 128 in client device 108 to request permission to transfer application data elements from application session data element store 502 to an application executable instance 506 running in another application container 118 on trusted application server 104. The request may be sent by application container 118 using procedures associated with process 900. Browser subsystem 128 at client device 108 may display the request on an output display through I/O subsystem 130, and may receive the client response through an input device controlled by I/O subsystem 130. Browser subsystem 128 may forward the client authorization or denial to session store manager 500 in container 118, which may receive and process the response using procedures associated with process 800.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for controlling access to application data by a remotely hosted application, the method comprising:
receiving, from a remote application, a request for access to an application data element storage location associated with the application and a client of the application, the request including credentials for the client provided from a client device and for the remote application;
authenticating the client credentials and the remote application credentials; and
allowing access to the storage location by the remote application based on access control information provided by the client of the client device, wherein allowing access by the remote application includes allowing writing an application data element to the storage location.

2. The method of claim 1 wherein allowing access by remote application includes sending a request to the client device to authorize the remote application request.

3. The method of claim 1 further comprising transferring a data usage policy for the requested application data element to the remote application, wherein the policy comprises rules for controlling use of the application data element.

4. The method of claim 3 wherein the policy is defined by or approved by a client of the remote application.

5. The method of claim 1 wherein writing an application data element to the storage location includes storing an application-generated data element associated with the client generated by the remote application.

6. The method of claim 1 wherein allowing access by the remote application includes allowing reading the contents of a storage location associated with an application data element.

7. A method for processing application data in an application container, the method comprising:
in an application container:
receiving, from a remote client device, a request to provide credentials to the client device guaranteeing enforcement of a data usage policy defining allowable usage by the application of an application data element associated with a client of the client device;
providing the requested credentials for review by the client device without presenting the data usage policy; and
providing for an application to process the application data element while enforcing the data usage policy.

8. The method of claim 7 wherein providing for an application to process the application data element includes at least one of transferring the application data outside the container and accessing a persistent storage location associated with the application data element.

9. The method of claim 7 further comprising deleting the application data element from the application container in response to termination of a session of processing the application data.

10. The method of claim 7 wherein providing for an application to process the application data element includes accessing a remote data store using credentials for a client of the client device and credentials for at least one of the application and the application container, and accessing a storage location associated with the application data element in the remote data store in compliance with the data usage policy.

11. The method of claim 7 wherein providing for an application to process the application data element while enforcing the identified data usage policy includes:
detecting an operation involving the transfer of the application data element outside the container;
determining whether the transfer complies with the data usage policy; and
preventing the transferring of the application data element when the transfer does not comply with the data usage policy.

12. The method of claim 7 wherein providing for an application to process the application data element while enforcing the identified data usage policy includes accessing a remote data store specified by the client device.

13. The method of claim 7 wherein the data usage policy allows the persistent storage of the application data element by the application only in a remote trusted data store under the control of the client of the client device.

14. A method for controlling processing of data in a remote application container from a client device, the method comprising:
at a client device:
requesting an executable session for communicating with a remote application container;
providing authorization to a remote data store to permit the remote application container to access storage associated with an application data element associated with a client of the client device during the executable session; and
providing authorization to the remote application container to allow a remote application to access the storage associated with the application data element during the executable session.

15. A trusted data store system for controlling access to application data to a remotely hosted application, the system comprising:
a data store comprising at least one application data element storage location associated with a client of the application;
a request manager operable to receive, from a remote application, a request for access to an application data element storage location, the request including credentials for the client provided from a client device and for the remote application;
a trusted application services manager operable to authenticate the client credentials and the remote application credentials; and
a database manager operable to allow access to the storage location by the remote application based on access control information provided by the client of the client device, wherein allowing access by the remote application includes writing an application data element to the storage location.

16. The system of claim 15 wherein the trusted application services manager is operable to request from the client device authorization of the remote application request.

17. The system of claim 15 wherein the database manager is operable to transfer a data usage policy for the requested application data element to the remote application, and wherein the policy comprises rules for controlling use of the application data element.

18. The system of claim 17 wherein the usage policy is defined by or approved by a client of the client device.

19. The system of claim 15 wherein the database manager is operable to store an application-generated data element associated with a client of the application.

20. The system of claim 15 wherein allowing access by the remote application includes reading the contents of a storage location associated with the application data element.

21. An application container system for processing data in an application container, the system comprising:
an application session data element store comprising at least one application element data storage location;
a data store client operable to receive, from a remote client device, a request to provide credentials to the client device guaranteeing enforcement of a data usage policy defining allowable usage by the application of an application data element associated with a client of the client device;
a session store manager to provide the requested credentials to the client device without presenting the data usage policy; and
an application executable instance to process the application data while the data usage policy is enforced.

22. The system of claim 21 wherein the session store manager is operable to at least one of transferring the application data outside the container and accessing a persistent storage location associated with the application data element.

23. The system of claim 21 wherein the session store manager is operable to delete the application data element from the application container in response to termination of an executable session processing the application data element.

24. The system of claim 21 wherein the application executable instance is operable to access a remote data store using credentials for a client of the client device and credentials for at least one of the application and the application container, and access a storage location associated with the application data element in the remote data store in compliance with the data usage policy.

25. The system of claim 21 wherein the container is operable to:
detect an operation involving the transfer of the application data element outside the container;
determine whether the transfer complies with the data usage policy; and
prevent the transferring of the application data when the transfer does not comply with the data usage policy.

26. The system of claim 21 wherein the data store client is operable to access a remote data store specified by the client device.

27. The system of claim 21 wherein the data store client is operable to allow the application data to be stored persistently by the application only in a remote trusted data store under the control of the client of the client device.

28. A client device system for controlling processing of data in a remote application container from a client device, the system comprising:
an I/O subsystem to manage at least one local input device and at least one graphical client interface display;
a browser operable to request an executable session for processing an application data element at a remote application container;
a browser operable to provide authorization to a remote data store to permit the remote application container to access storage associated with an application data element associated with a client of the client device; and
a browser operable to provide authorization to the remote application container to permit a remote application to access the storage associated with the application data element in the processing of the application data element in the remote application container.

29. A system for controlling access to application data by a remotely hosted application, the system comprising:
means for receiving, from a remote application, a request for access to an application data element storage location associated with the application and a client of the application, the request including credentials for the client provided from a client device and for the remote application;
means for authenticating the client credentials and the remote application; and
means for allowing access to the storage location by the remote application based on access control information provided by the client of the client device wherein allowing access by the remote application includes allowing writing an application data element to the storage location.

30. A system for processing data in an application container, the system comprising:
means for receiving, from a remote client device, a request to provide credentials to the client device guaranteeing enforcement of a data usage policy defining allowable usage by the application of an application data element associated with a client of the client device;
means for providing the requested credentials for review by the client device without presenting the data usage policy; and
means for providing for an application to process the application data element while enforcing the data usage policy.

31. A system for controlling processing of application data in a remote application container from a client device, the system comprising:
means for requesting an executable session for communicating with a remote application container;
means for providing authorization to a remote data store to permit the remote application container to access storage associated with an application data element associated with a client of the client device during the executable session; and
means for providing authorization to the remote application container to allow a remote application to access the storage associated with the application data element during the executable session.

32. A computer program product comprising computer executable instructions embodied in a computer readable medium for performing steps comprising:
receiving, from a remote application, a request for access to an application data element storage location associated with the application and a client of the application, the request including credentials for the client provided from a client device and for the remote application;
authenticating the client credentials and the remote application; and
allowing access to the storage location by the remote application based on access control information provided by the client of the client device, wherein allowing access by the remote application includes writing an application data element to the storage location.

33. A computer program product comprising computer executable instructions embodied in a computer readable medium for performing steps comprising:
receiving, from a remote client device, a request to provide credentials to the client device guaranteeing enforcement of a data usage policy defining allowable usage by the application of an application data element associated with a client of the client device;
providing the requested credentials for review by the client device without presenting the data use policy; and
providing for an application to process the application data element while enforcing the data usage policy.

34. A computer program product comprising computer executable instructions embodied in a computer readable medium for performing steps comprising:
requesting an executable session for communicating with a remote application container;
providing authorization to a remote data store to permit the remote application container to access storage associated with an application data element associated with a client of the client device during the executable session; and
providing authorization to the remote application container to allow a remote application to access the storage associated with the application data element during the executable session.
